(19) United States
(12) Patent Application Publication
(10) Pub. No.: US 2024/0424376 A1
(43) Pub. Date: Dec. 26, 2024

(54) NON-MOTORIZED RUNNING MACHINE, WHICH IS MOVED BY SOLES AND CONTROLS SCROLLING OF WEB CONTENT AT CADENCE SPEED, AND DRIVING METHOD THEREFOR

(71) Applicant: TESFY Co.,Ltd., Seongnam-si (KR)

(72) Inventors: Woo-Jun CHOI, Seongnam-si (KR); Yong-Ho KIM, Seongnam-si (KR)

(21) Appl. No.: 18/700,405

(22) PCT Filed: May 24, 2022
(86) PCT No.: PCT/KR2022/007357

§ 371 Date: Apr. 11, 2024

(30) Foreign Application Priority Data
Feb. 10, 2022 (KR) 10-2022-0017582

(51) Int. Cl. A63B 71/06; A63B 22/02; A63B 24/00; G06F 3/0485

(52) U.S. Cl. CPC A63B 71/0622; A63B 22/02; A63B 24/0006; A63B 24/0062; G06F 3/0485; A63B 2220/30

(57) ABSTRACT

A non-motorized treadmill includes a web content provider configured to classify attributes of web content into a text and an image and to provide attribute information about the web content; and a controller configured to control a scroll speed for the text at a first speed based on a first weight value according to a user's cadence speed, a second weight value according to an exercise intensity, and a first reference scroll speed for the text, and to control a scroll speed for the image at a second speed based on the first weight value, the second weight value, and a second reference scroll speed for the image.

### TECHNICAL FIELD

The embodiment of the present invention relates to a non-motorized treadmill of controlling scrolling of web content by a cadence speed moving with a sole of foot and a driving method therefor.

### BACKGROUND ART

Although there are numerous exercise facilities and exercise equipment for physical activity and exercise, busy modern people absolutely lack an amount of daily physical activity due to the convenience of life, compared to the amount of caloric intake. In addition, outdoor exercise is restricted due to the effects of fine dust, air pollution, ultraviolet rays, and the like. Furthermore, the time spent using smart devices by Koreans aged 15 or older is 2.0 hours on weekdays and 2.3 hours on holidays, and is increasing every year (Statistics Korea, 2020 Korean Social Indicators).

Aerobic exercise on a treadmill (also known as a running machine) or a cycle machine, which are representative means of indoor exercise, is very effective for the body but can easily become boring due to simple repetitive motions. Aerobic exercise is a time-consuming exercise, so it is easy for users to give up exercise halfway because it is difficult to overcome the boredom of using exercise equipment and the boredom of time consumption.

### DISCLOSURE

### Technical Problem

The embodiment of the present invention attempts to provide a non-motorized treadmill including an android board and a touch panel-type monitor provided on a front surface part of an indoor aerobic exercise equipment so that most people can do aerobic exercise simultaneously while consuming media and web contents that they enjoy using smart devices habitually in life, the treadmill being capable of providing a user with a sense of immersion and motivation by controlling scrolling of web content by a cadence speed moving with a sole of foot according to various web content attributes to change hand scrolling to foot scrolling, and a driving method for the non-motorized treadmill.

### Technical Solution

A non-motorized treadmill according to an exemplary embodiment of the present invention includes a web content provider configured to classify attributes of web content into a text and an image and to provide attribute information about the web content; and a controller configured to control a scroll speed for the text at a first speed based on a first weight value according to a user's cadence speed, a second weight value according to an exercise intensity, and a first reference scroll speed for the text, and to control a scroll speed for the image at a second speed based on the first weight value, the second weight value, and a second reference scroll speed for the image.

The controller may be configured to control the scroll speed for the text at the first speed, which is a value obtained by multiplying the first weight value and the second weight value by the first reference scroll speed.

The controller may be configured to control the scroll speed for the image at the second speed, which is a value obtained by multiplying the first weight value and the second weight value by the second reference scroll speed.

The second reference scroll speed may be greater than the first reference scroll speed.

The controller may be configured to increase the scroll speed for the text and the scroll speed for the image in proportion to the user's cadence speed.

The controller may be configured to increase the scroll speed for the text and the scroll speed for the image in proportion to the exercise intensity.

The first weight value may be set within a range from 0 to a predetermined first value, and the second weight value may be set within a range from 1 to a predetermined second value.

The controller may be configured to control the scroll speed for the text at the first speed, which is a value obtained by multiplying the first weight value and the second weight value by the first reference scroll speed and further multiplying a resultant value by a third weight value according to a user's setting, and to control the scroll speed for the image at the second speed, which is a value obtained by multiplying the first weight value and the second weight value by the second reference scroll speed and further multiplying a resultant value by the third weight value.

The controller may be configured to check an attribute of each web content by checking a URL address of the web content as the attribute information about the web content.

A method for driving a non-motorized treadmill by a controller of the non-motorized treadmill according to another exemplary embodiment of the present invention includes checking whether an attribute of web content belong to a text or an image, calculating a first weight value according to a user's cadence speed, calculating a second weight value according to an exercise intensity, and controlling a scroll speed for the text at a first speed based on the first weight value, the second weight value, and a first reference scroll speed for the text, and controlling a scroll speed for the image at a second speed based on the first weight value, the second weight value, and a second reference scroll speed for the image.

### Advantageous Effects

The non-motorized treadmill and the driving method therefor according to the exemplary embodiments of the present invention can motivate the user to exercise without getting bored by controlling the scrolling of the web content in conjunction with the cadence speed moving with the sole of the user's foot.

In general, aerobic exercise is difficult to do for more than 30 minutes, and web content is usually seen on a smartphone. Regarding this, the non-motorized treadmill according to the exemplary embodiment of the present invention allows the user to continuously exercise by scrolling web content in conjunction with the user's cadence speed.

### DESCRIPTION OF THE DRAWINGS

FIG. 1 is a block diagram showing a non-motorized treadmill according to an exemplary embodiment of the present invention.

FIG. 2 is a flow chart showing a method for driving a non-motorized treadmill according to an exemplary embodiment of the present invention.

FIG. 3 shows an example of a web content selection interface displayed on a display unit of the non-motorized treadmill according to the exemplary embodiment of the present invention.

FIG. 4 shows an example in which a web content is scrolled according to a user's cadence speed and a weight value on the non-motorized treadmill according to the exemplary embodiment of the present invention.

FIG. 5 shows an example in which a screen brightness or resolution of a web content is adjusted according to a user's cadence speed and a weight value on the non-motorized treadmill according to the exemplary embodiment of the present invention.

### MODE FOR INVENTION

In the following detailed description, only certain exemplary embodiments of the present invention have been shown and described, simply by way of illustration. The present invention can be variously implemented and is not limited to the following exemplary embodiments.

The drawings and description are to be regarded as illustrative in nature and not restrictive. Like reference numerals designate like elements throughout the specification.

In addition, unless explicitly described to the contrary, the word “comprise”, and variations such as “comprises” or “comprising”, will be understood to imply the inclusion of stated elements but not the exclusion of any other elements.

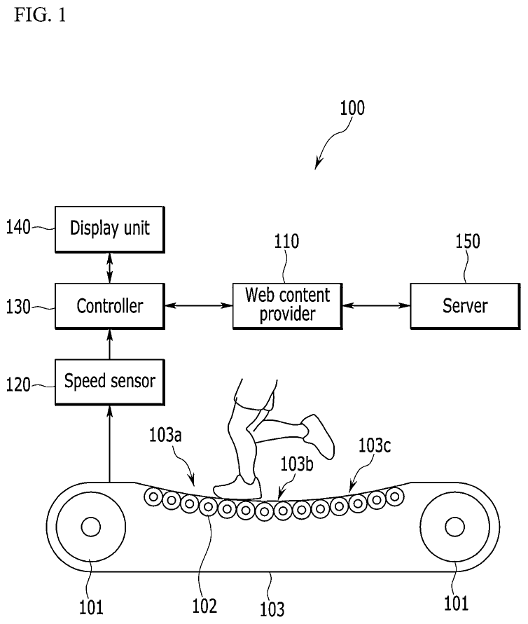

FIG. 1 is a block diagram showing a non-motorized treadmill according to an exemplary embodiment of the present invention.

Referring to FIG. 1, a non-motorized treadmill 100 according to an exemplary embodiment of the present invention may be non-motorized exercise equipment. Although the non-motorized treadmill 100 is described as an example of an exemplary embodiment of the present invention, the exemplary embodiment of the present invention may include all non-motorized exercise equipment in which a speed of, for example, rotation of a component can be determined by a motion speed such as a user's cadence. Examples of the non-motorized exercise equipment include a bike device (cycling device), a rowing machine (rowing exercise equipment), a stepmill machine (stair walking exercise equipment), and the like. In a case in which the non-motorized exercise equipment is the non-motorized treadmill 100, the cadence speed may correspond to a user's running speed. In a case in which the non-motorized exercise equipment is a bike device, the cadence speed may correspond to a user's pedaling speed. In a case in which the non-motorized exercise equipment is a rowing machine, the cadence speed may correspond to a user's rowing speed. In a case in which the non-motorized exercise equipment is a stepmill machine, the cadence speed may correspond to a user's stepping speed.

The non-motorized treadmill 100 according to an exemplary embodiment of the present invention will be described below.

The non-motorized treadmill 100 may basically include two first rotation parts 101, a plurality of second rotation parts 102, and a track part 103. The non-motorized treadmill 100 may be a non-motorized device that does not include a drive unit for rotating the track part 103 and rotates the track part 103 by a user's foot motion moving with soles of feet.

The first rotation parts 101 are arranged at both ends of an endless track formed by the track part 103 and support the track part 103 to rotate in the endless track (closed loop). The first rotation parts 101 may include a brake device, and an exercise intensity can be set by adjusting a degree of braking of the brake device according to a user's setting. The set exercise intensity may be provided to a controller 130.

The plurality of second rotation parts 102 may be arranged between the two first rotation parts 101 to support an upper part of the endless track formed by the track part 103. The plurality of second rotation parts 102 may be arranged in a curved shape so that a central portion of the upper part of the endless track is concave. The plurality of second rotation parts 102 may be ball bearings for rotating the track part 103.

The track part 103 may rotate while forming the endless track (closed loop) in which both ends are supported by the first rotation parts 101 and the upper part is supported by the plurality of second rotation parts 102.

When a user makes a foot motion of running forward on the track part 103, a force of relatively moving the track part 103 backward is applied to the track part 103. The running includes motions that the user walks or runs. The track part 103 is rotated by the user's foot motion because it is rotatably supported by the first rotation parts 101 and the plurality of second rotation parts 102. When the user walks or runs slowly, the track part 103 rotates slowly, when the user walks or runs quickly, the track part 103 rotates quickly, and when the user stops, the track part 103 stops. That is, a rotation speed of the track part 103 may correspond to a user's cadence speed (running speed).

For example, the upper part of the track part 103, where the user steps, has a concave center and thus may be divided into a front region 103a, a central region 103b, and a rear region 103c. The central region 103b is a relatively flat part, and the front region 103a and the rear region 103c are inclined parts. When the user steps on the front region 103a, the force exerted on the track part 103 by the user may increase, resulting in an increase in the rotation speed of the track part 103. When the user steps on the rear region 103c, the force exerted on the track part 103 by the user may be opposite to a rotation direction of the track part 103, resulting in a decrease in the rotation speed of the track part 103. In this way, the rotation speed of the track part 103 can be actively controlled by the user's running.

The non-motorized treadmill 100 may include a web content provider 110, a speed sensor 120, a controller 130, a display unit 140, and a server 150 in order to provide a user with a sense of immersion and motivation.

The web content provider 110 may store web content including at least one of a text and an image, or may stream the web content in real time in association with the server 150. In other words, the web content may be provided from the outside via the Internet. The text may include news, novels, and the like. The image may include photos, webtoons, and the like. In an exemplary embodiment, the web content provider 110 may include a video as the web content. The video may include live-action videos of nature, movies, YouTube videos, advertising videos, and the like.

The web content provider 110 may provide a web content selected by the user to the controller 130. The web content provider 110 can classify attributes of web content into a text and an image, and provide attribute information about the web content to the controller 130 together with the web content. The attribute information about the web content may include a URL (Uniform Resource Locator) address of a website where the web content is provided.

The speed sensor 120 may measure a rotation speed of the track part 103 according to the user's running and provide the rotation speed to the controller 130. In an exemplary embodiment, the speed sensor 120 may be configured to measure a rotation speed of the first rotation part 101 or the second rotation part 102.

The controller 130 may provide a web content selection interface to the user through the display unit 140, and may receive a web content selected on the web content selection interface from the web content provider 110. The controller 130 may scroll the web content on the display unit 140 in response to the rotation speed of the track part 103 (user's cadence speed) according to the attribute of the web content.

The scroll may mean that a web content displayed on a screen of the display unit 140 moves up and down or left and right. The scroll may mean an action of moving a text or an image on the screen up and down or left and right in order to see content that is not visible on the screen. Scrolling up may mean that the entire content on the screen moves up line by line, and accordingly, a new line appears at the bottom of the screen and a line at the top disappears.

The controller 130 can adjust a scroll speed for web content that is scrolling on the display unit 140. The controller 130 may increase the scroll speed for the web content in proportion to the user's cadence speed.

In addition, the controller 130 may adjust the scroll speed for the web content that is scrolling on the display unit 140, according to the set exercise intensity. The controller 130 may increase the scroll speed for the web content in proportion to the intensity of exercise.

The controller 130 may set a reference scroll speed according to the attribute of the web content. The reference scroll speed may include a first reference scroll speed V1 for a text and a second reference scroll speed V2 for an image. The second reference scroll speed V2 for an image may be greater than the first reference scroll speed V1 for a text. This takes into account the fact that a speed at which a user sees a text is slower than a speed at which the user sees an image. For example, when the first reference scroll speed V1 is 1, the second reference scroll speed V2 may be 3. The first reference scroll speed V1 and the second reference scroll speed V2 may be adjusted as needed or by the user.

The controller 130 may set the user's cadence speed as a first weight value W1 and the exercise intensity as a second weight value W2. The first weight value W1 may be set within a range from 0 to a predetermined first value, and the second weight value W2 may be set within a range from 1 to a predetermined second value. The first weight value W1 may increase in proportion to the user's cadence speed. The second weight value W2 may increase in proportion to the exercise intensity.

In this case, the controller 130 may calculate a scroll speed V for web content as a value obtained by multiplying the reference scroll speed (V1, V2) by the first weight value W1 and the second weight value W2. In other words, the scroll speed V for web content may be V=(V1 or V2)×W1×W2. The controller 130 may control the scroll speed V for web content by the calculated value. In other words, the controller 130 may control a scroll speed for a text at a first speed based on the first weight value W1, the second weight value W2, and the first reference scroll speed V1, and may control a scroll speed for an image at a second speed based on the first weight value W1, the second weight value W2, and the second reference scroll speed V2.

For example, assuming that the attribute of web content is a text, the first reference scroll speed V1 is 1, the first weight value W1 is adjusted within a range from 0 to 3 according to the user's cadence speed, and the second weight value W2 is adjusted within a range from 1 to 2 according to the exercise intensity, the scroll speed V for the web content (the scroll speed for the text) may be controlled within a range from 0 to 6.

Assuming that the attribute of web content is an image, the second reference scroll speed V2 is 3, the first weight value W1 is adjusted within a range from 0 to 3 according to the user's cadence speed, and the second weight value W2 is adjusted within a range from 1 to 2 according to the exercise intensity, the scroll speed V for the web content (the scroll speed for the image) may be controlled within a range from 0 to 18.

The ranges of the first weight value W1 and the second weight value W2 may be adjusted as needed or by the user.

Note that there may be individual differences in speed at which each user reads a text or sees an image. Considering the individual differences, a third weight value W3 may be additionally applied to the scroll speed V for web content. The third weight value W3 may be set/changed by the user even while the web content is scrolling, and the controller 130 may further apply the third weight value W3 to the scroll speed V for the web content. The third weight value W3 may be set to a predetermined third value equal to or greater than 1. For example, the third weight value W3 may be set within a range from 1 to 4.

In this case, the controller 130 may calculate the scroll speed V for web content as a value obtained by multiplying the reference scroll speed (V1, V2) by the first weight value W1 and the second weight value W2 and further multiplying a resultant value by the third weight value W3. In other words, the scroll speed V for web content may be V=(V1 or V2)×W1×W2×W3. In other words, the controller 130 may control the scroll speed for the text at the first speed, which is a value obtained by multiplying the first reference scroll speed V1 by the first weight value W1 and the second weight value W2 and further multiplying a resultant value by the third weight value W3, and control the scroll speed for the image at the second speed, which is a value obtained by multiplying the second reference scroll speed V2 by the first weight value W1and the second weight value W2 and further multiplying a resultant value by the third weight value W3.

In an exemplary embodiment, the controller 130 may adjust a brightness or resolution of a video displayed on the display unit 140, in response to the rotation speed of the track part 103 (user's cadence speed). In this case, the controller 130 may set a reference brightness or resolution value for the video according to the attribute of the web content, calculate a value obtained by multiplying the reference brightness or resolution value by the first weight value W1 and the second weight value W2, and adjust the brightness or resolution of the video according to the calculated value. In addition, the controller 130 may calculate a value obtained by multiplying the reference brightness or resolution value by the first weight value W1 and the second weight value W2 and further multiplying a resultant value by the third weight value W3 set/changed by the user, and adjust the brightness or resolution of the video according to the calculated value.

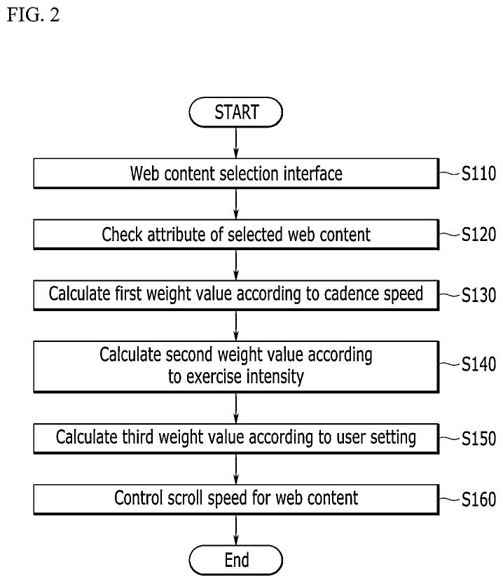

Hereinafter, a method for driving the non-motorized treadmill 100 according to an exemplary embodiment of the present invention will be described with reference to FIGS. 2 to 5 along with FIG. 1.

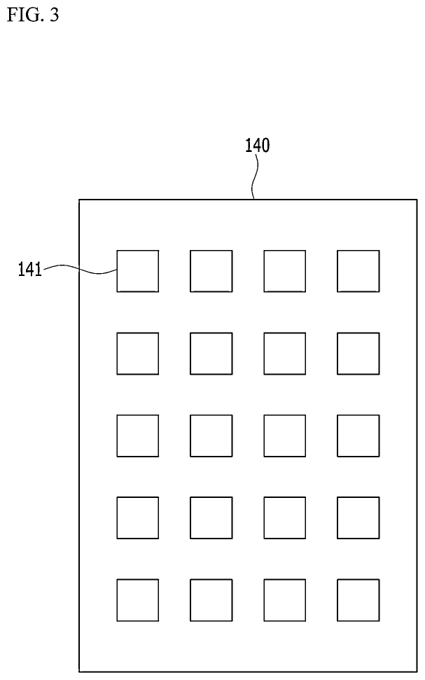

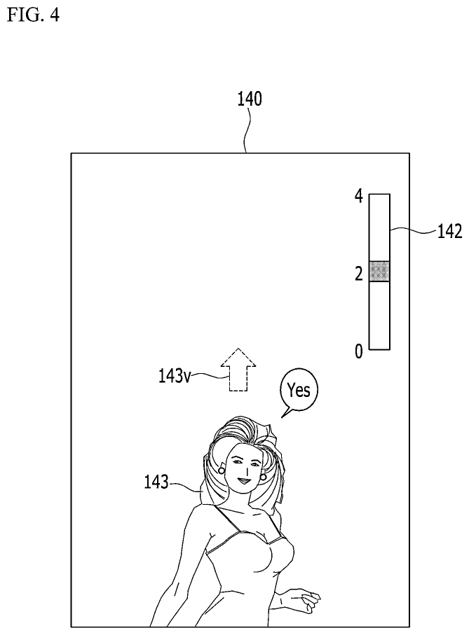

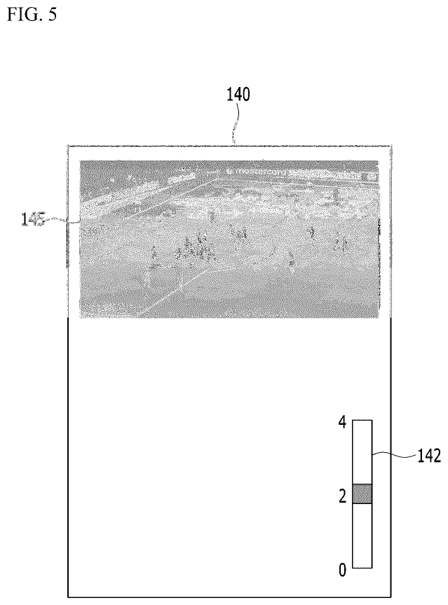

FIG. 2 is a flow chart showing a method for driving a non-motorized treadmill according to an exemplary embodiment of the present invention. FIG. 3 shows an example of a web content selection interface displayed on a display unit of the non-motorized treadmill according to the exemplary embodiment of the present invention. FIG. 4 shows an example in which a web content is scrolled according to a user's cadence speed and a weight value on the non-motorized treadmill according to the exemplary embodiment of the present invention. FIG. 5 shows an example in which a screen brightness or resolution of a web content is adjusted according to a user's cadence speed and a weight value on the non-motorized treadmill according to the exemplary embodiment of the present invention.

Referring to FIGS. 1 to 5, the user can start using the non-motorized treadmill 100 by entering a personal ID and a password on the display unit 140, and a web content selection interface may be displayed on the display unit 140 at the time of start of use of the non-motorized treadmill 100 or in response to a user's request (S110). The web content selection interface may be a screen where icons 141 for selecting various types of texts, images and the like are displayed, as illustrated in FIG. 3. The user can select one or more web contents from the web content selection interface. In addition, the web content selection interface may be displayed on the display unit 140 in the form of an icon even while the web content is scrolling, and the user can change or add web content even while the web content is scrolling.

The controller 130 checks an attribute of the selected web content (S120). That is, the controller 130 may check whether an attribute of the selected web content belongs to a text or an image by checking the attribute information about the web content provided by the web content provider 110. The controller 130 may check an attribute of each web content by checking a URL address of the web content as the attribute information about the web content. At this time, the controller 130 may select the first reference scroll speed V1 when the attribute of the selected web content is a text, and select the second reference scroll speed V2 when the attribute of the selected web content is an image. Additionally, the controller 130 may check whether the attribute of the selected web content is a video by checking the attribute information about the web content, and may set a reference brightness or resolution value when the attribute of the selected web content is a video.

The controller 130 may measure the user's cadence speed by measuring the rotation speed of the track part 103 through the speed sensor 120, and calculate the first weight value W1 according to the cadence speed (S130).

The controller 130 may calculate the second weight value W2 according to the exercise intensity set in the non-motorized treadmill 100 (S140).

The controller 130 may calculate the third weight value W3 according to a user setting (S150). As illustrated in FIG. 4, the controller 130 may display a weight value selection menu 142 so that the third weight value W3 can be selected on the screen of the display unit 140 where a web content (image) 143 is displayed. The weight value selection menu 142 may be formed in a form of a vertical bar or a horizontal bar, and the user may select a scroll speed 143v suitable for the user by using the weight value selection menu 142. A type or a position on the screen of the weight value selection menu 142 may be changed in various ways. For example, the weight value selection menu 142 may be subdivided so that the third weight value W3 is analogously selected within a range from 0 to 4. In an exemplary embodiment, the process of calculating the third weight value W3 may be omitted.

In addition, as illustrated in FIG. 5, the controller 130 may display the weight value selection menu 142 so that the third weight value W3 can be selected on the screen of the display unit 140 where a video 145 is displayed.

The controller 130 may calculate the scroll speed V for the web content by multiplying the first reference scroll speed V1 or the second reference scroll speed V2 according to the attribute of the web content by the first weight value W1, the second weight value W2, and the third weight value W3, and can control the scroll speed for the web content displayed on the display unit 140 according to the calculated scroll speed V (S160). The third weight value W3 may be omitted, and in this case, the controller 130 may calculate the scroll speed V for the web content by multiplying the first reference scroll speed V1 or the second reference scroll speed V2 according to the attribute of the web content by the first weight value W1 and the second weight value W2, and control the scroll speed for the web content.

When the attribute of the web content is a video, the controller 130 may set a reference brightness or resolution value for the video, calculate a value obtained by multiplying the reference brightness or resolution value by the first weight value W1 and the second weight value W2, and adjust the brightness or resolution of the video according to the calculated value. In addition, the controller 130 may calculate a value obtained by multiplying the reference brightness or resolution value by the first weight value W1 and the second weight value W2 and further multiplying a resultant value by the third weight value W3 set/changed by the user, and adjust the brightness or resolution of the video according to the calculated value. The controller 130 may maintain a video playback speed at a constant speed and adjust the brightness or resolution of the video in response to the user's cadence speed.

In general, aerobic exercise is difficult to do for more than 30 minutes, and web content is usually seen on a smartphone. Regarding this, the non-motorized treadmill 100 according to the exemplary embodiment of the present invention allows the user to continuously exercise and can motivate the user to exercise without getting bored by scrolling the web content at the user's cadence speed.

The drawings and the detailed description of the invention referenced so far are merely illustrative of the present invention, are used only for the purpose of describing the present invention, and are not intended to define the meanings thereof or to limit the scope of the present invention set forth in the claims. Therefore, one skilled in the art will understand that various modifications and other equivalent exemplary embodiments are possible from the drawings and the detailed description. Consequently, the true technical protective scope of the present invention should be determined based on the technical spirit of the attached claims.

### Industrial Applicability

The present invention relates to a non-motorized treadmill of controlling scrolling of web content by a cadence speed moving with a sole of foot and a driving method therefor, and has industrial applicability.

1. A non-motorized treadmill comprising:
a web content provider configured to classify attributes of web content into a text and an image and to provide attribute information about the web content; and
a controller configured to control a scroll speed for the text at a first speed based on a first weight value according to a user's cadence speed, a second weight value according to an exercise intensity, and a first reference scroll speed for the text, and to control a scroll speed for the image at a second speed based on the first weight value, the second weight value, and a second reference scroll speed for the image.

2. The non-motorized treadmill of claim 1, wherein
the controller is configured to control the scroll speed for the text at the first speed, which is a value obtained by multiplying the first weight value and the second weight value by the first reference scroll speed.

3. The non-motorized treadmill of claim 1, wherein
the controller is configured to control the scroll speed for the image at the second speed, which is a value obtained by multiplying the first weight value and the second weight value by the second reference scroll speed.

4. The non-motorized treadmill of claim 1, wherein
the second reference scroll speed is greater than the first reference scroll speed.

5. The non-motorized treadmill of claim 1, wherein
the controller is configured to increase the scroll speed for the text and the scroll speed for the image in proportion to the user's cadence speed.

6. The non-motorized treadmill of claim 1, wherein
the controller is configured to increase the scroll speed for the text and the scroll speed for the image in proportion to the exercise intensity.

7. The non-motorized treadmill of claim 1, wherein
the first weight value is set within a range from 0 to a predetermined first value, and the second weight value is set within a range from 1 to a predetermined second value.

8. The non-motorized treadmill of claim 1, wherein
the controller is configured to control the scroll speed for the text at the first speed, which is a value obtained by multiplying the first weight value and the second weight value by the first reference scroll speed and further multiplying a resultant value by a third weight value according to a user's setting, and to control the scroll speed for the image at the second speed, which is a value obtained by multiplying the first weight value and the second weight value by the second reference scroll speed and further multiplying a resultant value by the third weight value.

9. The non-motorized treadmill of claim 1, wherein
the controller is configured to check an attribute of each web content by checking a URL address of the web content as the attribute information about the web content.

10. A method for driving a non-motorized treadmill by a controller of the non-motorized treadmill, the method comprising:
checking whether an attribute of web content belong to a text or an image;
calculating a first weight value according to a user's cadence speed;
calculating a second weight value according to an exercise intensity; and
controlling a scroll speed for the text at a first speed based on the first weight value, the second weight value, and a first reference scroll speed for the text, and controlling a scroll speed for the image at a second speed based on the first weight value, the second weight value, and a second reference scroll speed for the image.

11. The method of claim 10, wherein
the scroll speed for the text is controlled at the first speed, which is a value obtained by multiplying the first weight value and the second weight value by the first reference scroll speed.

12. The method of claim 10, wherein
the scroll speed for the image is controlled at the second speed, which is a value obtained by multiplying the first weight value and the second weight value by the second reference scroll speed.

13. The method of claim 10, wherein
the second reference scroll speed is greater than the first reference scroll speed.

14. The method of claim 10, wherein
the scroll speed for the text and the scroll speed for the image are increased in proportion to the user's cadence speed.

15. The method of claim 10, wherein
the scroll speed for the text and the scroll speed for the image are increased in proportion to the exercise intensity.

16. The method of claim 10, wherein
the first weight value is set within a range from 0 to a predetermined first value, and the second weight value is set within a range from 1 to a predetermined second value.

17. The method of claim 10,
further comprising calculating a third weight value according to a user's setting,
wherein the scroll speed for the text is controlled at the first speed, which is a value obtained by multiplying the first weight value and the second weight value by the first reference scroll speed and further multiplying a resultant value by a third weight value according to a user's setting, and the scroll speed for the image is controlled at the second speed, which is a value obtained by multiplying the first weight value and the second weight value by the second reference scroll speed and further multiplying a resultant value by the third weight value.

18. The method of claim 10, wherein
an attribute of each web content is checked by checking a URL address of the web content as the attribute information about the web content.
